(19) United States
(12) Patent Application Publication
(10) Pub. No.: US 2025/0326257 A1
(43) Pub. Date: Oct. 23, 2025

(54) WEAR DETERMINATION SYSTEM, WEAR DETERMINATION DEVICE, AND INFORMATION TRANSMISSION DEVICE

(71) Applicants: TOYOTA JIDOSHA KABUSHIKI KAISHA, Toyota-shi (JP); ADVICS CO., LTD., Kariya-shi (JP)

(72) Inventors: Yoshihisa YAMADA, Nagoya-shi (JP); Fumitake MURAKAMI, Nagoya-shi (JP); Tomoya TANAKA, Kariya-shi (JP); Yasufumi ENAMI, Kariya-shi (JP)

(73) Assignees: TOYOTA JIDOSHA KABUSHIKI KAISHA, Toyota-shi (JP); ADVICS CO., LTD., Kariya-shi (JP)

(21) Appl. No.: 19/085,459

(22) Filed: Mar. 20, 2025

(30) Foreign Application Priority Data
Apr. 22, 2024 (JP) 2024-069109

(51) Int. Cl. B60C 11/24; B60W 40/12

(52) U.S. Cl. CPC B60C 11/246; B60W 40/12; B60W 2520/14; B60W 2540/18

(57) ABSTRACT

A wear determination system determines wear of a target wheel that is a steered wheel included in a vehicle. The wear determination system calculates a ground speed of the target wheel and a rotation speed of the target wheel in the same section where the vehicle is turning right or left, and calculates a curved-traveling wheel radius based on the ground speed and the rotation speed. The curved-traveling wheel radius is a dynamic loaded radius of the target wheel that corresponds to the vehicle turning right or left. The wear determination system determines wear of a shoulder portion of the target wheel based on the curved-traveling wheel radius.

### CROSS-REFERENCE TO RELATED APPLICATIONS

This application is based upon and claims the benefit of priority from Japanese Patent Application No. 2024-069109, filed on Apr. 22, 2024, the entire contents of which are incorporated herein by reference.

### BACKGROUND

### 1. Field

The present disclosure relates to a wear determination system, a wear determination device, and an information transmission device.

### 2. Description of Related Art

Japanese Laid-Open Patent Publication No. 2021-172280 describes a wear determination system. This wear determination system determines wear of a wheel based on a distance by which the wheel has moved along with traveling of a vehicle and a number of rotations the wheel has made while covering that distance.

The wheel includes a tread portion that contacts the ground when the vehicle is traveling straight, and shoulder portions that contact the ground when the vehicle is turning right or left. The wear determination system of the above publication does not distinguish the tread portion and the shoulder portions when determining the degree of wear. Therefore, the wear determination system of the above publication is unable to focus on the shoulder portions of the wheel to determine wear.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In a first general aspect, a wear determination system determines wear of a target wheel that is a steered wheel included in a vehicle. The wear determination system is configured to calculate a ground speed of the target wheel and a rotation speed of the target wheel. The ground speed and the rotation speed are acquired in a same section where the vehicle is turning right or left. The wear determination system is also configured to calculate a curved-traveling wheel radius, which is a dynamic loaded radius of the target wheel that corresponds to the vehicle turning right or left, based on the ground speed and the rotation speed. The wear determination system is further configured to determine wear of a shoulder portion of the target wheel based on the curved-traveling wheel radius.

In a second general aspect, a wear determination device determines wear of a target wheel that is a steered wheel included in a vehicle. The wear determination device includes processing circuitry that is configured to determine wear of a shoulder portion of the target wheel based on a curved-traveling wheel radius, which is a dynamic loaded radius of the target wheel that corresponds to the vehicle turning right or left. The curved-traveling wheel radius is calculated based on a ground speed of the target wheel and a rotation speed of the target wheel that are acquired in a same section where the vehicle is turning right or left.

In a third general aspect, an information transmission device is configured to communicate with the wear determination device according to the second general aspect. The information transmission device includes processing circuitry and a communication device. The processing circuitry of the information transmission device is configured to calculate the ground speed of the target wheel and the rotation speed of the target wheel in the same section where the vehicle is turning right or left, and calculate the curved-traveling wheel radius based on the ground speed and the rotation speed. The communication device is configured to transmit the curved-traveling wheel radius to the wear determination device.

Other features and aspects will be apparent from the following detailed description, the drawings, and the claims.

### BRIEF DESCRIPTION OF THE DRAWINGS

FIG. 1 is a schematic diagram illustrating a configuration of a wear determination system according to one embodiment.

FIG. 2 is a diagram illustrating a wheel included in a vehicle.

FIG. 3 is a diagram illustrating a state of a steered wheel of the vehicle when the vehicle is traveling straight.

FIG. 4 is a diagram illustrating a state of the steered wheel of the vehicle when the vehicle is turning right.

FIG. 5 is a sequence diagram illustrating a mode of communication for determining a steering angle of a steering wheel included in the vehicle in the wear determination system of FIG. 1.

FIG. 6 is a graph illustrating one example of a transition of a steering angle of the steering wheel according to an operation of a user of the vehicle.

FIG. 7 is a flowchart illustrating processes for the wear determination system of FIG. 1 to calculate a straight-traveling wheel radius of a target wheel.

FIG. 8 is a flowchart illustrating processes for the wear determination system of FIG. 1 to calculate a curved-traveling wheel radius of the target wheel.

FIG. 9 is a diagram illustrating a relationship between a turning center and turning angles of steered wheels of the vehicle when the vehicle turns right.

FIG. 10 is a sequence diagram illustrating a mode of communication for a wear determination device to determine wear of a shoulder portion of the target wheel in the wear determination system of FIG. 1.

FIG. 11 is a table illustrating one example of information transmitted from an information transmission device to the wear determination device in the wear determination system of FIG. 1.

FIG. 12 is a sequence diagram illustrating a mode of communication for the wear determination device to determine wear of the shoulder portion of the target wheel in the wear determination system of a first modification.

Throughout the drawings and the detailed description, the same reference numerals refer to the same elements. The drawings may not be to scale, and the relative size, proportions, and depiction of elements in the drawings may be exaggerated for clarity, illustration, and convenience.

### DETAILED DESCRIPTION

This description provides a comprehensive understanding of the methods, apparatuses, and/or systems described. Modifications and equivalents of the methods, apparatuses, and/or systems described are apparent to one of ordinary skill in the art. Sequences of operations are exemplary, and may be changed as apparent to one of ordinary skill in the art, with the exception of operations necessarily occurring in a certain order. Descriptions of functions and constructions that are well known to one of ordinary skill in the art may be omitted.

Exemplary embodiments may have different forms, and are not limited to the examples described. However, the examples described are thorough and complete, and convey the full scope of the disclosure to one of ordinary skill in the art.

In this specification, “at least one of A and B” should be understood to mean “only A, only B, or both A and B.”

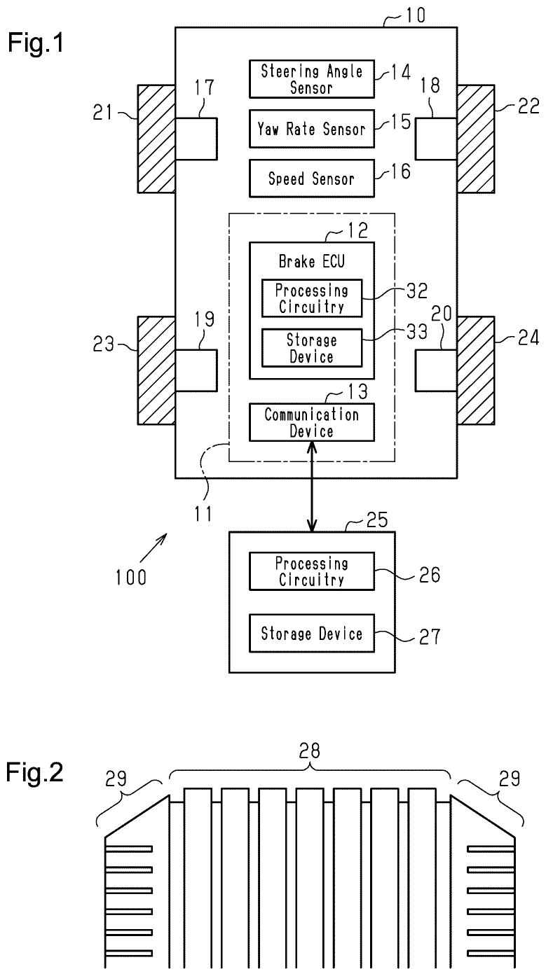

Hereinafter, a wear determination system according to an embodiment will be described with reference to FIGS. 1 to 11.

### Configuration of Wear Determination System 100

As illustrated in FIG. 1, a wear determination system 100 includes a vehicle 10 and a wear determination device 25.

As illustrated in FIG. 1, the vehicle 10 includes an information transmission device 11. The information transmission device 11 includes a brake ECU 12 and a communication device 13.

The brake ECU 12 is an electronic control device that controls brakes included in the vehicle 10. The brake ECU 12 generates information on the vehicle 10 based on information from multiple sensors included in the vehicle 10.

The brake ECU 12 includes a storage device 33 in which programs are stored, and processing circuitry 32 that executes the programs stored in the storage device 33 and executes various processes. The processing circuitry 32 includes a processor.

The information transmission device 11 may be connected to the wear determination device 25 in a wired or wireless manner. The communication device 13 transmits information on the vehicle 10 generated by the brake ECU 12 to the wear determination device 25. In this manner, the information transmission device 11 transmits the information on the vehicle 10 to the wear determination device 25. The information transmitted by the information transmission device 11 will be described later.

The brake ECU 12 acquires information from a steering angle sensor 14, a yaw rate sensor 15, a speed sensor 16, and wheel speed sensors in order to generate the information on the vehicle 10.

The steering angle sensor 14 measures a steering angle of a steering wheel of the vehicle 10. The steering angle sensor 14 transmits the measured steering angle to the brake ECU 12.

The yaw rate sensor 15 measures a yaw rate of the vehicle 10. The yaw rate sensor 15 transmits the measured yaw rate to the brake ECU 12.

The speed sensor 16 measures a moving speed of the vehicle 10. Specifically, the speed sensor 16 measures the moving speed of the vehicle 10 based on a rotation speed of any of a crankshaft, a transmission, a motor, and the like of an engine. The speed sensor 16 transmits the measured moving speed of the vehicle 10 to the brake ECU 12.

As illustrated in FIG. 1, the vehicle 10 includes four wheel-speed sensors, which are an FL wheel speed sensor 17, an FR wheel speed sensor 18, an RL wheel speed sensor 19, and an RR wheel speed sensor 20.

The FL wheel speed sensor 17 measures a rotation speed of an FL wheel 21. The FL wheel 21 is disposed on the front left side of the vehicle 10. The FL wheel speed sensor 17 transmits the measured rotation speed of the FL wheel 21 to the brake ECU 12.

The FR wheel speed sensor 18 measures a rotation speed of an FR wheel 22. The FR wheel 22 is disposed on the front right side of the vehicle 10. The FR wheel speed sensor 18 transmits the measured rotation speed of the FR wheel 22 to the brake ECU 12.

The RL wheel speed sensor 19 measures a rotation speed of an RL wheel 23. The RL wheel 23 is disposed on the rear left side of the vehicle 10. The RL wheel speed sensor 19 transmits the measured rotation speed of the RL wheel 23 to the brake ECU 12.

The RR wheel speed sensor 20 measures a rotation speed of an RR wheel 24. The RR wheel 24 is disposed on the rear right side of the vehicle 10. The RR wheel speed sensor 20 transmits the measured rotation speed of the RR wheel 24 to the brake ECU 12.

As illustrated in FIG. 1, the wear determination device 25 includes a storage device 27 in which programs are stored, and processing circuitry 26 that executes the programs stored in the storage device 27 and executes various processes. The processing circuitry 26 includes a processor. The wear determination device 25 is, for example, a server installed outside the vehicle 10.

Each of the processing circuitry 26 and the processing circuitry 32 may include one or more dedicated hardware circuits such as an application specific integrated circuit (ASIC) that executes at least some processes among various processes. Alternatively, each of the processing circuitry 26 and the processing circuitry 32 may include a combination of one or more processors and one or more dedicated hardware circuits. Each processor may include a CPU and memory modules such as RAM and ROM. The memory modules may store program codes or instructions configured to cause the CPU to execute processes. The memory modules, that is, computer-readable media include any available medium that can be accessed by a general-purpose or dedicated computer.

### Outline of Shoulder Portions 29 of Target Wheel

The wear determination device 25 determines wear of shoulder portions 29 of the target wheel based on the information on the vehicle 10 received from the information transmission device 11.

The target wheel is a wheel which is targeted by the wear determination device 25 and the wear determination system 100 for determination. The wear determination device 25 and the wear determination system 100 target a steered wheel included in the vehicle 10 for determination. The steered wheels of the vehicle 10 are the FL wheel 21 and the FR wheel 22. The target wheels of the wear determination device 25 and the wear determination system 100 are the FL wheel 21 and the FR wheel 22.

FIG. 2 illustrates a target wheel included in the vehicle 10. The wheel illustrated in FIG. 2 is, for example, the FL wheel 21. As illustrated in FIG. 2, the target wheel includes a tread portion 28 and the shoulder portions 29. The shoulder portions 29 include a shoulder portion 29 on the right side in the traveling direction and a shoulder portion 29 on the left side in the traveling direction. In the following description, the shoulder portion 29 on the right side in the traveling direction is simply referred to as right shoulder portion 29, and the shoulder portion 29 on the left side in the traveling direction is simply referred to as left shoulder portion 29.

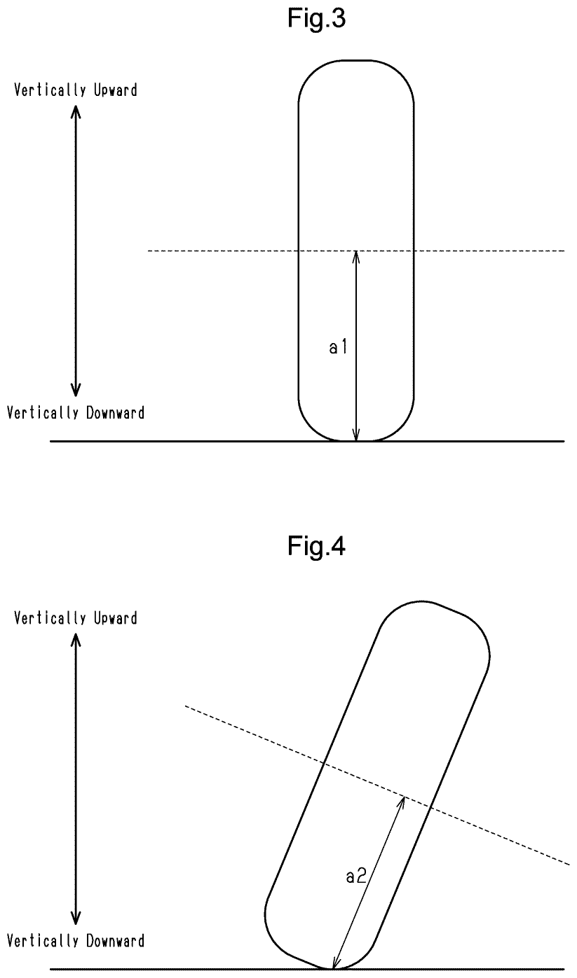

When the vehicle 10 is traveling straight, the tread portion 28 contacts the ground on the target wheel. FIG. 3 illustrates a state of the target wheel when the vehicle 10 is traveling straight. For example, the wheel illustrated in FIG. 3 is the FL wheel 21.

When the vehicle 10 is turning right, the target wheel is inclined with respect to the ground according to the turning angle of the target wheel, and thus, a portion at which the target wheel contacts the ground changes. While the turning angle of the target wheel is smaller than a specific angle, a portion of the target wheel between the tread portion 28 and the right shoulder portion 29 contacts the ground. When the turning angle of the target wheel is larger than the specific angle, the right shoulder portion 29 contacts the ground.

FIG. 4 illustrates a state of the target wheel when the vehicle 10 is turning right in a state in which the turning angle of the target wheel is larger than the specific angle. For example, the wheel illustrated in FIG. 4 is the FL wheel 21. When the vehicle 10 is turning right, the target wheel is inclined to the right with respect to the ground as illustrated in FIG. 4. When the turning angle of the target wheel is larger than the specific angle, the right shoulder portion 29 contacts the ground.

When the vehicle 10 is turning left, the portion at which the target wheel contacts the ground changes according to the turning angle of the target wheel, similarly to when the vehicle 10 is turning right. While the turning angle of the target wheel is smaller than the specific angle, a portion of the target wheel between the tread portion 28 and the left shoulder portion 29 contacts the ground. When the turning angle of the target wheel is larger than the specific angle, the left shoulder portion 29 contacts the ground.

The sign “a1” in FIG. 3 indicates a straight-traveling wheel radius of the target wheel. The straight-traveling wheel radius is a dynamic loaded radius of the target wheel when the vehicle 10 is traveling straight.

The sign “a2” in FIG. 4 indicates a curved-traveling wheel radius of the target wheel. The curved-traveling wheel radius is a dynamic loaded radius of the target wheel when the vehicle 10 is turning right or left.

The more the shoulder portions 29 of the target wheel wear, the smaller the curved-traveling wheel radius becomes. The wear determination device 25 determines wear of the shoulder portions 29 of the target wheel based on the curved-traveling wheel radius.

Mode of Communication for Calculating Straight-Traveling Wheel Radius and Curved-Traveling Wheel Radius

The information transmission device 11 transmits information indicating the straight-traveling wheel radius and the curved-traveling wheel radius as the information on the vehicle 10. As described above, the brake ECU 12 generates the information on the vehicle 10. The brake ECU 12 calculates the straight-traveling wheel radius and the curved-traveling wheel radius based on information from multiple sensors included in the vehicle 10, thereby generating the information on the vehicle 10.

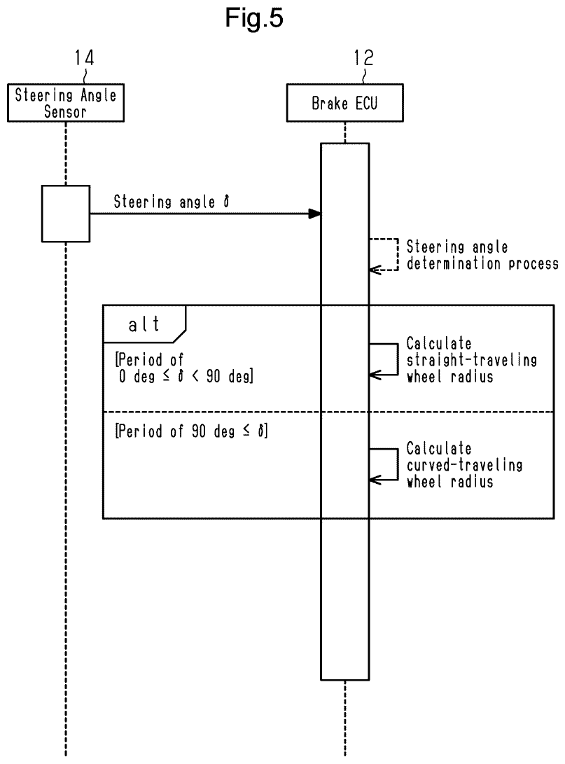

FIG. 5 illustrates a mode of communication executed by the brake ECU 12 to calculate the straight-traveling wheel radius and the curved-traveling wheel radius. In FIG. 5, the processes executed by the brake ECU 12 are executed by the processing circuitry 32.

The brake ECU 12 calculates the straight-traveling wheel radius and the curved-traveling wheel radius based on values measured by multiple sensors included in the vehicle 10 within a calculation period. The calculation period is a specific period within the period during which the vehicle 10 is traveling.

As illustrated in FIG. 5, the steering angle sensor 14 transmits information indicating the steering angle of the steering wheel by the operation of the user of the vehicle 10 to the brake ECU 12. The steering angle sensor 14 transmits information indicating the transition of the steering angle of the steering wheel in the calculation period to the brake ECU 12. Hereinafter, in the drawings, the value of the steering angle indicated by the information transmitted by the steering angle sensor 14 is expressed as 8.

As illustrated in FIG. 5, the brake ECU 12 that has received the information indicating the steering angle from the steering angle sensor 14 executes a steering angle determination process. The steering angle determination process is a process of dividing the calculation period based on the steering angle indicated by the information received from the steering angle sensor 14.

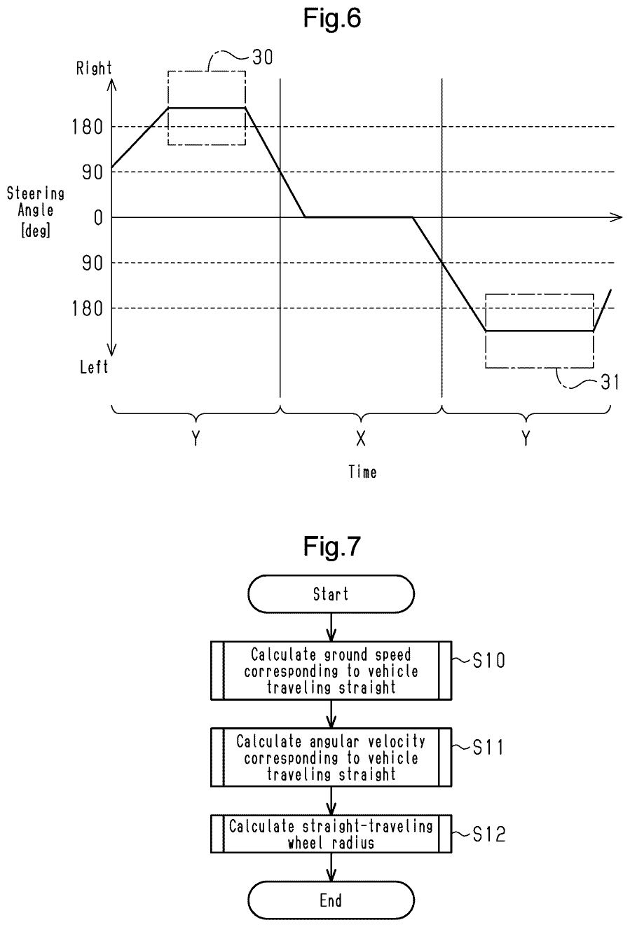

FIG. 6 illustrates the transition of the steering angle of the steering wheel within the calculation period indicated by the information received by the brake ECU 12 from the steering angle sensor 14.

In the graph of FIG. 6, the vertical axis represents the steering angle of the steering wheel measured by the steering angle sensor 14. In the graph of FIG. 6, the horizontal axis represents time.

In the graph of FIG. 6, the steering wheel is not turned to either the left or the right in a period during which the steering angle is zero. In the graph of FIG. 6, the steering wheel is turned to the right in a period during which the steering angle is above the horizontal axis. In the graph of FIG. 6, the steering wheel is turned to the left in a period during which the steering angle is below the horizontal axis.

In the steering angle determination process, the brake ECU 12 divides the calculation period into an X period and a Y period illustrated in FIG. 6.

The X period illustrated in FIG. 6 is a period in which the steering angle of the steering wheel is greater than or equal to 0 degrees and less than 90 degrees. The Y period illustrated in FIG. 6 is a period in which the steering angle of the steering wheel is greater than or equal to 90 degrees.

As illustrated in FIG. 5, after executing the steering angle determination process, the brake ECU 12 executes different processes according to the type of the period.

As illustrated in FIG. 5, the brake ECU 12 calculates the straight-traveling wheel radius based on information measured by multiple sensors included in the vehicle 10 in a period during which the steering angle of the steering wheel is greater than or equal to 0 degrees and less than 90 degrees. That is, the brake ECU 12 calculates the straight-traveling wheel radius based on the information measured by the sensors included in the vehicle 10 in the X period. In the present embodiment, the wear determination system 100 determines that the vehicle 10 is traveling straight when the steering angle of the steering wheel is greater than or equal to 0 degrees and less than 90 degrees.

As illustrated in FIG. 5, the brake ECU 12 calculates the curved-traveling wheel radius based on information measured by multiple sensors included in the vehicle 10 in a period during which the steering angle of the steering wheel is greater than or equal to 90 degrees. That is, the brake ECU 12 calculates the curved-traveling wheel radius based on the information measured by the sensors included in vehicle 10 in the Y period. In the present embodiment, the wear determination system 100 determines that the vehicle 10 is turning right or left when the steering angle of the steering wheel is greater than or equal to 90 degrees.

### Mode of Process Executed for Calculating Straight-Traveling Wheel Radius

FIG. 7 illustrates a series of flows of processes executed by the brake ECU 12 to calculate the straight-traveling wheel radius. After executing the steering angle determination process illustrated in FIG. 5, the brake ECU 12 executes a series of processes illustrated in FIG. 7 based on information measured by multiple sensors included in the vehicle 10 in the X period. The series of processes illustrated in FIG. 7 is executed by the processing circuitry 32.

As described above, the target wheels are the FL wheel 21 and the FR wheel 22. The brake ECU 12 executes a series of processes illustrated in FIG. 7 for each of the FL wheel 21 and the FR wheel 22. Hereinafter, a first case in which the brake ECU 12 calculates the straight-traveling wheel radius of the FL wheel 21 will be described with reference to FIG. 7.

In the process of step S10, the brake ECU 12 calculates a ground speed of the target wheel that corresponds to the vehicle 10 traveling straight. In the first case, the brake ECU 12 calculates the ground speed of the FL wheel 21 that corresponds to the vehicle 10 traveling straight.

In order to calculate the ground speed of the FL wheel 21 that corresponds to the vehicle 10 traveling straight, the brake ECU 12 stores the radius of a wheel that is not a target wheel, that is, a non-target wheel, among the wheels included in the vehicle 10. The brake ECU 12 stores an average of the radii of the RL wheel 23 and the RR wheel 24 as the radius of the non-target wheel.

In order to calculate the ground speed of the FL wheel 21 that corresponds to the vehicle 10 traveling straight, the brake ECU 12 acquires the rotation speed in the X period for a wheel that is not a target wheel among the wheels included in the vehicle 10. The brake ECU 12 acquires an average of the rotation speeds of the RL wheel 23 and the RR wheel 24 in the X period as the rotation speed of the non-target wheel. The brake ECU 12 acquires the rotation speed of the RL wheel 23 in the X period from the RL wheel speed sensor 19. The brake ECU 12 acquires the rotation speed of the RR wheel 24 in the X period from the RR wheel speed sensor 20.

The ground speed of the target wheel that corresponds to the vehicle 10 traveling straight is the same as the ground speed of the non-target wheel. Assuming that when the vehicle 10 is traveling straight, the ground speed of the FL wheel 21 is V1, the average of the radii of the RL wheel 23 and the RR wheel 24 is r, and the average of the rotation speeds of the RL wheel 23 and the RR wheel 24 in the X period of FIG. 6 is N, the following relationship holds.

$$V 1 = 2 π r \times N \qquad [ Equation 1 ]$$

In this manner, the brake ECU 12 calculates the ground speed of the FL wheel 21 that corresponds to the vehicle 10 traveling straight.

In the process of step S11, the brake ECU 12 calculates an angular velocity of the target wheel that corresponds to the vehicle 10 traveling straight. In the first case, the brake ECU 12 calculates the angular velocity of the FL wheel 21 that corresponds to the vehicle 10 traveling straight.

The brake ECU 12 acquires the rotation speed of the FL wheel 21 in the X period from the FL wheel speed sensor 17 in order to calculate the angular speed of the FL wheel 21 that corresponds to the vehicle 10 traveling straight.

Assuming that when the vehicle 10 is traveling straight, the angular velocity of the FL wheel 21 is ω1, and the rotation speed of the FL wheel 21 in the X period is N1, the following relationship holds.

$$ω 1 = 2 π \times N 1 \qquad [ Equation 2 ]$$

In this manner, the brake ECU 12 calculates the angular velocity of the FL wheel 21 that corresponds to the vehicle 10 traveling straight.

In the process of step S12, the brake ECU 12 calculates the straight-traveling wheel radius of the target wheel. In the first case, the brake ECU 12 calculates the straight-traveling wheel radius of the FL wheel 21.

Assuming that the straight-traveling wheel radius of the FL wheel 21 is b1, the following relationship holds.

$$b 1 = \frac{V 1}{ω 1} \qquad [ Equation 3 ]$$

In this manner, the brake ECU 12 calculates the straight-traveling wheel radius of the FL wheel 21.

The wear determination system 100 calculates the straight-traveling wheel radius based on the ground speed of the target wheel and the rotation speed of the target wheel acquired in the same section where the vehicle 10 is traveling straight.

### Outline of Determination Period Extraction Process

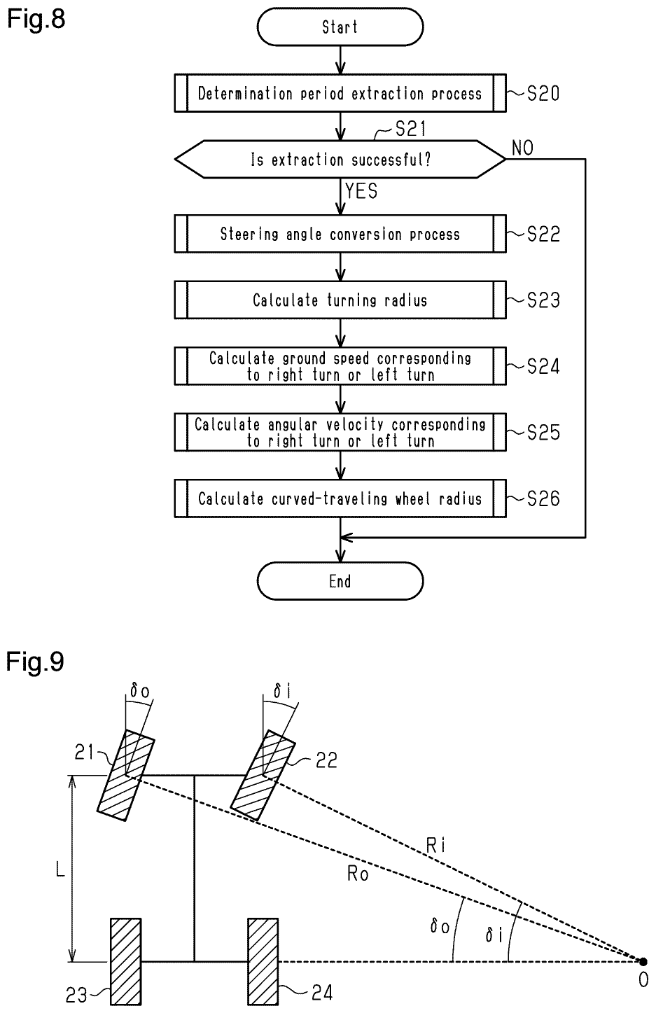

FIG. 8 illustrates a series of flows of processes executed by the brake ECU 12 to calculate the curved-traveling wheel radius. After executing the steering angle determination process illustrated in FIG. 5, the brake ECU 12 executes a series of processes illustrated in FIG. 8 based on information measured by multiple sensors included in the vehicle 10 in the “Y” period. The series of processes illustrated in FIG. 8 is executed by the processing circuitry 32.

The brake ECU 12 calculates the curved-traveling wheel radius for each of the right shoulder portion 29 and the left shoulder portion 29 of the FL wheel 21. The brake ECU 12 calculates the curved-traveling wheel radius for each of the right shoulder portion 29 and the left shoulder portion 29 of the FR wheel 22. The brake ECU 12 executes the series of processes illustrated in FIG. 8 for each shoulder portion 29 of the target wheel.

In the process of step S20, the brake ECU 12 executes a determination period extraction process. The determination period extraction process is a process of extracting a period for calculating the curved-traveling wheel radius from the Y period.

The brake ECU 12 extracts a period during which the following three conditions are satisfied as a period for calculating the curved-traveling wheel radius.

The first condition is that the turning angle of the target wheel is relatively large. As will be described later, the brake ECU 12 uses the ground speed of the target wheel that corresponds to the vehicle 10 turning left or right to calculate the curved-traveling wheel radius. As described with reference to FIGS. 2 to 4, the shoulder portions 29 of the target wheel contact the ground when the turning angle of the target wheel is larger than the specific angle. The curved-traveling wheel radius calculated based on the ground speed of the target wheel that corresponds to the turning angle of the target wheel being smaller than the specific angle may not accurately reflect the degree of wear of the shoulder portions 29 of the target wheel.

The brake ECU 12 extracts a period in which the turning angle of the FL wheel 21 is larger than a predetermined angle reference value as a period for calculating the curved-traveling wheel radius. In the present embodiment, although not limited thereto, the angle reference value is, for example, the turning angle of the target wheel that corresponds to the steering angle of the steering wheel of the vehicle 10 being 180 degrees.

The turning angle of the target wheel with respect to the steering angle of the steering wheel differs between the FL wheel 21 and the FR wheel 22. The turning angle of the target wheel with respect to the steering angle of the steering wheel differs depending on whether the steering wheel is turned left or right. Therefore, the angle reference value differs depending on the direction in which the steering wheel is turned and the position of the target wheel.

The turning angle of the target wheel increases according to the steering angle of the steering wheel of the vehicle 10. The brake ECU 12 extracts a period in which the steering angle of the steering wheel is larger than 180 degrees from the Y period to extract a period in which the turning angle of the target wheel is larger than the angle reference value. The wear determination system 100 does not calculate the curved-traveling wheel radius when the turning angle of the target wheel that corresponds to the vehicle 10 turning right or turning left is less than or equal to the angle reference value.

The second condition is that the turning angle of the target wheel is constant. As will be described later, the brake ECU 12 calculates the curved-traveling wheel radius using the turning angle of the target wheel. During a period in which the turning angle of the target wheel is changing, the brake ECU 12 cannot accurately calculate the curved-traveling wheel radius.

The third condition is that the moving speed of the vehicle 10 is relatively slow. When the vehicle 10 turns right or left in a state in which the moving speed of the vehicle 10 is high, the vehicle 10 slips. When the vehicle 10 slips, the brake ECU 12 cannot accurately calculate the ground speed of the target wheel.

The brake ECU 12 extracts a period in which the moving speed of the vehicle 10 that corresponds to the vehicle 10 turning right or left is lower than a predetermined speed reference value as a period for calculating the curved-traveling wheel radius.

In the present embodiment, the speed reference value is 15 km/h. The brake ECU 12 extracts a period in which the moving speed is lower than the speed reference value from the Y period based on the moving speed of the vehicle 10 received from the speed sensor 16. The wear determination system 100 does not calculate the curved-traveling wheel radius when the moving speed of the vehicle 10 that corresponds to the vehicle 10 turning right or left is greater than or equal to the speed reference value. The speed reference value is not limited to 15 km/h.

Two portions surrounded by the long-dash short-dash lines in FIG. 6 correspond to periods extracted by the brake ECU 12 as periods for calculating the curved-traveling wheel radius.

As described with reference to FIGS. 2 to 4, when the vehicle 10 is turning right and the turning angle of the target wheel is larger than the specific angle, the right shoulder portion 29 contacts the ground. The wear determination system 100 can determine wear of the right shoulder portion 29 by calculating the curved-traveling wheel radius that corresponds to the vehicle 10 turning right. One of two portions surrounded by the long-dash short-dash lines in FIG. 6 corresponds to a right-turn determination period 30 for calculating the curved-traveling wheel radius that corresponds to the vehicle 10 turning right.

As described with reference to FIGS. 2 to 4, when the vehicle 10 is turning left and the turning angle of the target wheel is larger than the specific angle, the left shoulder portion 29 contacts the ground. The wear determination system 100 can determine wear of the left shoulder portion 29 by calculating the curved-traveling wheel radius that corresponds to the vehicle 10 turning left. The other of the two portions surrounded by the long-dash short-dash lines in FIG. 6 corresponds to a left-turn determination period 31 for calculating the curved-traveling wheel radius that corresponds to the vehicle 10 turning left.

In step S21, the brake ECU 12 determines whether extraction of a period for calculating the curved-traveling wheel radius has succeeded in the determination period extraction process of step S20.

When there is no period satisfying the above three conditions in the calculation period, the brake ECU 12 cannot extract a period for calculating the curved-traveling wheel radius. The brake ECU 12 determines that the extraction of the period is not successful when the period for calculating the curved-traveling wheel radius is not extracted in the determination period extraction process.

The brake ECU 12 determines that the extraction of the period is not successful in a case in which the right-turn determination period 30 is not extracted when the process of FIG. 8 is executed to determine whether the right shoulder portion 29 is worn. The brake ECU 12 determines that the extraction of the period is not successful in a case in which the left-turn determination period 31 is not extracted when the process of FIG. 8 is executed to determine the wear of the left shoulder portion 29.

When the brake ECU 12 determines that the extraction of the period is not successful (step S21: NO), the brake ECU 12 ends the series of processes illustrated in FIG. 8.

On the other hand, the brake ECU 12 determines that the extraction of the period is successful when the period for calculating the curved-traveling wheel radius is extracted in the determination period extraction process. When the brake ECU 12 determines that the extraction of the period is successful (step S21: YES), the brake ECU 12 advances the process to the next step, step S22.

In the processes from step S22 onward, the brake ECU 12 calculates the curved-traveling wheel radii of the FL wheel 21 and the FR wheel 22 that correspond to the vehicle 10 turning right based on the information of the sensors in the right-turn determination period 30. In the processes from step S22 onward, the brake ECU 12 calculates the curved-traveling wheel radii of the FL wheel 21 and the FR wheel 22 that correspond to the vehicle 10 turning left based on the information of the sensors in the left-turn determination period 31.

### Mode of Process Executed for Calculating Curved-Traveling Wheel Radius

Hereinafter, with reference to FIGS. 8 and 9, a second case will be described that is a case of calculating the curved-traveling wheel radius that corresponds to the vehicle 10 turning right for the FL wheel 21 among the target wheels included in the vehicle 10.

In the process of step S22, the brake ECU 12 executes a steering angle conversion process. The turning angle of the target wheel corresponding to the steering angle of the steering wheel included in the vehicle 10 is determined in advance. The brake ECU 12 stores a turning angle of a steered wheel corresponding to the steering angle of the steering wheel included in the vehicle 10. In the steering angle conversion process, the brake ECU 12 calculates the turning angle of the target wheel in the period for calculating the curved-traveling wheel radius based on the steering angle of the steering wheel in the period for calculating the curved-traveling wheel radius. In the second case, the brake ECU 12 calculates the turning angle of the FL wheel 21 in the right-turn determination period 30 based on the steering angle of the steering wheel in the right-turn determination period 30.

In the process of step S23, the brake ECU 12 calculates a turning radius of the target wheel that corresponds to the vehicle 10 turning right or left. In the second case, the brake ECU 12 calculates the turning radius of the FL wheel 21 that corresponds to the vehicle 10 turning right.

FIG. 9 illustrates a relationship between a turning center and the turning angles of the steered wheels at the time when the vehicle 10 is turning right. In FIG. 9, a point O indicates the turning center. In FIG. 9, L indicates a wheelbase length of the vehicle 10.

In FIG. 9, δo indicates the turning radius of the FL wheel 21 that corresponds to the vehicle 10 turning right. In FIG. 9, δi indicates the turning radius of the FR wheel 22 that corresponds to the vehicle 10 turning right.

In FIG. 9, 80 indicates the turning angle of the FL wheel 21 that corresponds to the vehicle 10 turning right. In FIG. 9, 8i indicates the turning angle of the FR wheel 22 that corresponds to the vehicle 10 turning right.

As illustrated in FIG. 9, the angle formed by the straight line connecting the RL wheel 23 and the RR wheel 24 and the straight line indicating the turning radius of the FL wheel 21 is equal to the turning angle of the FL wheel 21. As illustrated in FIG. 9, the angle formed by the straight line connecting the RL wheel 23 and the RR wheel 24 and the straight line indicating the turning radius of the FR wheel 22 is equal to the turning angle of the FR wheel 22.

The following relationship holds based on the relationship illustrated in FIG. 9.

$$Ro = \frac{L}{sin δ o} \qquad [ Equation 4 ]$$

In this manner, the brake ECU 12 calculates the turning radius of the FL wheel 21 that corresponds to the vehicle 10 turning right.

In the process of step S24, the brake ECU 12 calculates the ground speed of the target wheel that corresponds to the vehicle 10 turning right or left. In the second case, the brake ECU 12 calculates the ground speed of the FL wheel 21 that corresponds to the vehicle 10 turning right.

The brake ECU 12 acquires the yaw rate of the vehicle 10 in the right-turn determination period 30 from the yaw rate sensor 15 in order to calculate the ground speed of the FL wheel 21 that corresponds to the vehicle 10 turning right.

Assuming that when the vehicle 10 is turning right, the ground speed of the FL wheel 21 is V2 and the yaw rate of the vehicle 10 in the right-turn determination period 30 is Y, the following relationship holds.

$$V 2 = Ro \times Y \qquad [ Equation 5 ]$$

In this manner, the brake ECU 12 calculates the ground speed of the FL wheel 21 that corresponds to the vehicle 10 turning right. The wear determination system 100 calculates the ground speed of the target wheel that corresponds to the vehicle 10 turning right or left based on the yaw rate of the vehicle 10 and the turning angle of the target wheel acquired in the same section where the vehicle 10 is turning right or left, and the wheelbase length of the vehicle 10.

In the process of step S25, the brake ECU 12 calculates the angular velocity of the target wheel that corresponds to the vehicle 10 turning right or left. In the second case, the brake ECU 12 calculates the angular velocity of the FL wheel 21 that corresponds to the vehicle 10 turning right.

The brake ECU 12 acquires the rotation speed of the FL wheel 21 in the right-turn determination period 30 from the FL wheel speed sensor 17 in order to calculate the angular velocity of the FL wheel 21 that corresponds to the vehicle 10 turning right.

Assuming that when the vehicle 10 is turning right, the angular velocity of the FL wheel 21 is ω2 and the rotation speed of the FL wheel 21 in the right-turn determination period 30 is N2, the following relationship holds.

$$ω 2 = 2 π \times N 2 \qquad [ Equation 6 ]$$

In this manner, the brake ECU 12 calculates the angular velocity of the FL wheel 21 that corresponds to vehicle 10 turning right.

In the process of step S26, the brake ECU 12 calculates the curved-traveling wheel radius of the target wheel. In the second case, the brake ECU 12 calculates the curved-traveling wheel radius of the FL wheel 21 that corresponds to the vehicle 10 turning right.

Assuming that when the vehicle 10 is turning right, the curved-traveling wheel radius of the FL wheel 21 is b2, the following relationship holds.

$$b 2 = \frac{V 2}{ω 2} \qquad [ Equation 7 ]$$

In this manner, the brake ECU 12 calculates the curved-traveling wheel radius of the FL wheel 21 that corresponds to the vehicle 10 turning right. The wear determination system 100 and the information transmission device 11 calculate the curved-traveling wheel radius based on the ground speed of the target wheel and the rotation speed of the target wheel acquired in the same section where the vehicle 10 is turning right or left.

### Mode of Communication for Determination by Wear Determination Device 25

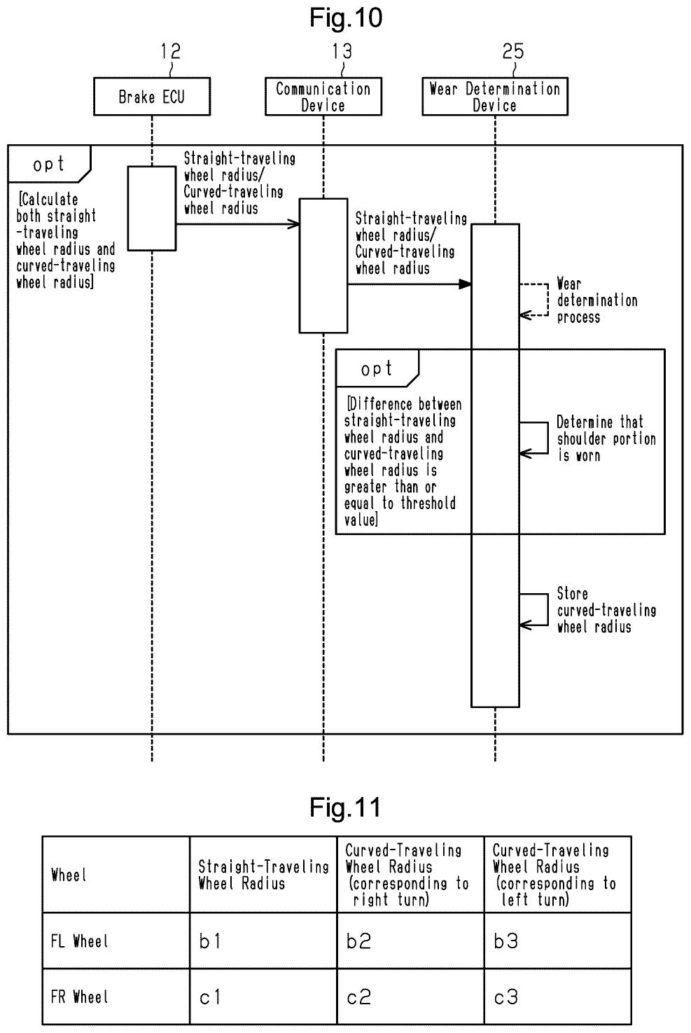

FIG. 10 illustrates a mode of communication that the wear determination device 25 executes to determine wear of the shoulder portions 29 of the target wheel. The communication of the mode illustrated in FIG. 10 is executed after the communication of the mode illustrated in FIG. 5 is executed. The communication of the mode illustrated in FIG. 10 is executed after the processes for calculating the straight-traveling wheel radius and the curved-traveling wheel radius are executed.

In FIG. 10, the processes executed by the brake ECU 12 are executed by the processing circuitry 32. In FIG. 10, the processes executed by the wear determination device 25 are executed by the processing circuitry 26.

As illustrated in the upper part of FIG. 10, the brake ECU 12 transmits information indicating the straight-traveling wheel radius and the curved-traveling wheel radius to the communication device 13. The communication device 13 transmits the information indicating the straight-traveling wheel radius and the curved-traveling wheel radius received from the brake ECU 12 to the wear determination device 25. The information transmission device 11 transmits the information indicating the straight-traveling wheel radius and the curved-traveling wheel radius to the wear determination device 25.

FIG. 11 illustrates one example of the straight-traveling wheel radius and the curved-traveling wheel radius indicated by the information transmitted from the information transmission device 11 to the wear determination device 25.

As described with reference to FIG. 7, the brake ECU 12 transmits information indicating the straight-traveling wheel radius for each of the FL wheel 21 and the FR wheel 22. In FIG. 11, the straight-traveling wheel radius of the FL wheel 21 calculated by the brake ECU 12 is b1. In FIG. 11, the straight-traveling wheel radius of the FR wheel 22 calculated by the brake ECU 12 is c1.

As described with reference to FIG. 8, the brake ECU 12 calculates the curved-traveling wheel radius based on the values of the sensors in the right-turn determination period 30 in order to determine wear of the right shoulder portion 29 of the FL wheel 21 and the FR wheel 22. In FIG. 11, the curved-traveling wheel radius of the FL wheel 21 calculated in the right-turn determination period 30 is b2. In FIG. 11, the curved-traveling wheel radius of the FR wheel 22 calculated in the right-turn determination period 30 is c2.

As described with reference to FIG. 8, the brake ECU 12 calculates the curved-traveling wheel radius based on the values of the sensors in the left-turn determination period 31 in order to determine wear of the left shoulder portion 29 of the FL wheel 21 and the FR wheel 22. In FIG. 11, the curved-traveling wheel radius of the FL wheel 21 calculated in the left-turn determination period 31 is b3. In FIG. 11, the curved-traveling wheel radius of the FR wheel 22 calculated in the left-turn determination period 31 is c3.

As illustrated in the upper part of FIG. 10, when both the straight-traveling wheel radius and the curved-traveling wheel radius are calculated, the brake ECU 12 transmits the information indicating the straight-traveling wheel radius and the curved-traveling wheel radius to the communication device 13. When at least one of the straight-traveling wheel radius and the curved-traveling wheel radius is not calculated, the brake ECU 12 transmits neither the information indicating the straight-traveling wheel radius nor the information indicating the curved-traveling wheel radius.

In the steering angle determination process illustrated in FIG. 5, when the steering angle of the steering wheel is greater than or equal to 0 degrees and does not fall below 90 degrees during the calculation period, the brake ECU 12 cannot calculate b1 and c1 of FIG. 11. In the determination period extraction process illustrated in FIG. 8, when the right-turn determination period 30 is not extracted, the brake ECU 12 cannot calculate b2 and c2 of FIG. 11. In the determination period extraction process illustrated in FIG. 8, when the left-turn determination period 31 is not extracted, the brake ECU 12 cannot calculate b3 and c3 of FIG. 11.

When all of b1, b2, b3, c1, c2, and c3 have been calculated, the brake ECU 12 transmits information indicating all the calculated values to the wear determination device 25. A configuration may be adopted in which even if the brake ECU 12 cannot calculate the curved-traveling wheel radius that corresponds to the vehicle 10 turning right, the brake ECU 12 transmits information indicating the calculated values to the wear determination device 25, provided that the brake ECU 12 has calculated the curved-traveling wheel radius and the straight-traveling wheel radius that corresponds to the vehicle 10 turning left. A configuration may be adopted in which even if the brake ECU 12 cannot calculate the curved-traveling wheel radius that corresponds to the vehicle 10 turning left, the brake ECU 12 transmits information indicating the calculated values to the wear determination device 25, provided that the brake ECU 12 has calculated the curved-traveling wheel radius and the straight-traveling wheel radius that corresponds to the vehicle 10 turning right.

As illustrated in the upper part of FIG. 10, the wear determination device 25 that has received the information indicating the straight-traveling wheel radius and the curved-traveling wheel radius executes a wear determination process. The wear determination process is a process of determining wear of the shoulder portions 29 of the target wheel based on the straight-traveling wheel radius and the curved-traveling wheel radius calculated by the information transmission device 11.

In the wear determination process, the wear determination device 25 observes a difference between the straight-traveling wheel radius and the curved-traveling wheel radius. The wear determination device 25 observes a difference between b1 and b2 when determining wear of the right shoulder portion 29 of the FL wheel 21. The wear determination device 25 observes a difference between b1 and b3 when determining wear of the left shoulder portion 29 of the FL wheel 21. The wear determination device 25 observes a difference between c1 and c2 when determining wear of the right shoulder portion 29 of the FR wheel 22. The wear determination device 25 observes a difference between c1 and c3 when determining wear of the left shoulder portion 29 of the FR wheel 22.

As the shoulder portions 29 are worn, the curved-traveling wheel radius decreases in a manner that the difference between the straight-traveling wheel radius and the curved-traveling wheel radius increases. As illustrated in the lower part of FIG. 10, the wear determination device 25 determines that the shoulder portions 29 of the target wheel are worn when the difference between the straight-traveling wheel radius and the curved-traveling wheel radius is greater than or equal to a threshold value.

The wear determination device 25 determines that the right shoulder portion 29 of the FL wheel 21 is worn when the difference between b1 and b2 is greater than or equal to a threshold value. For example, when the difference between b1 and b2 is larger than 2% of b1, the wear determination device 25 determines that the right shoulder portion 29 of the FL wheel 21 is worn.

As described above, the wear determination system 100 calculates the straight-traveling wheel radius, which is the dynamic loaded radius of the target wheel that corresponds to the vehicle 10 traveling straight. Thereafter, the wear determination system 100 determines that the shoulder portions 29 of the target wheel are worn when the difference between the curved-traveling wheel radius and the straight-traveling wheel radius is greater than or equal to the threshold value.

When the curved-traveling wheel radius is significantly smaller than the straight-traveling wheel radius, the shoulder portions 29 of the target wheel are worn as compared with the tread portion 28 of the target wheel. That is, when the curved-traveling wheel radius is significantly smaller than the straight-traveling wheel radius, uneven wear occurs in the shoulder portions 29 of the target wheel. The wear determination system 100 can particularly effectively determine that uneven wear of the shoulder portions 29 of the target wheel has occurred.

The wear determination device 25 similarly determines wear of the other shoulder portion 29 based on the difference between the straight-traveling wheel radius and the curved-traveling wheel radius. The wear determination system 100 determines wear of the right shoulder portion 29 of the target wheel using the curved-traveling wheel radius calculated based on the ground speed and the rotation speed that corresponds to the vehicle 10 turning right. The wear determination system 100 determines wear of the left shoulder portion 29 of the target wheel using the curved-traveling wheel radius calculated based on the ground speed and the rotation speed that corresponds to the vehicle 10 turning left.

As illustrated in the lower part of FIG. 10, after determining wear of the shoulder portions 29, the wear determination device 25 stores the curved-traveling wheel radius received from the information transmission device 11 in the storage device 27. As the shoulder portions 29 of the target wheel are worn, the curved-traveling wheel radius gradually decreases. The transition of the curved-traveling wheel radius of the target wheel is useful data for confirming the transition of the progress of wear of the shoulder portions 29 of the target wheel. As the wear determination device 25 stores the curved-traveling wheel radius, it is possible to confirm the transition of the curved-traveling wheel radius for the target wheel.

### Operation of the Present Embodiment

When the shoulder portions 29 of the target wheel are worn, the curved-traveling wheel radius of the target wheel decreases. The wear determination system 100 calculates the curved-traveling wheel radius based on the ground speed and the rotation speed of the target wheel that corresponds to the vehicle 10 turning right or left. The wear determination system 100 determines wear of the target wheel based on the curved-traveling wheel radius.

### Advantages of the Present Embodiment

(1) The wear determination system 100 can determine wear of the shoulder portions 29 of the target wheel based on the curved-traveling wheel radius, which is the dynamic loaded radius of the shoulder portions 29 of the target wheel.

(2) The wear determination system 100 calculates the ground speed of the target wheel that corresponds to the vehicle 10 turning right or left based on the yaw rate of the vehicle 10 and the turning angle of the target wheel acquired in the same section where the vehicle 10 is turning right or left, and the wheelbase length of the vehicle 10. As a result, the wear determination system 100 can obtain the ground speed of the target wheel that corresponds to the vehicle 10 turning right or left.

(3) The wear determination system 100 calculates the straight-traveling wheel radius, which is the dynamic loaded radius of the target wheel that corresponds to the vehicle 10 traveling straight. The wear determination system 100 determines that the shoulder portions 29 of the target wheel are worn when the difference between the curved-traveling wheel radius and the straight-traveling wheel radius is greater than or equal to the threshold value.

As the shoulder portions 29 of the target wheel are worn, the dynamic loaded radius that corresponds to the vehicle 10 turning right or left becomes smaller than the dynamic loaded radius that corresponds to the vehicle 10 traveling straight. The wear determination system 100 can determine wear of the shoulder portions 29 of the target wheel by observing the difference between the straight-traveling wheel radius and the curved-traveling wheel radius.

(4) The wear determination system 100 calculates the straight-traveling wheel radius based on the ground speed of the target wheel and the rotation speed of the target wheel acquired in the same section where the vehicle 10 is traveling straight. As a result, the wear determination system 100 can calculate the dynamic loaded radius of the target wheel that corresponds to the vehicle 10 traveling straight.

(5) The wear determination system 100 does not calculate the curved-traveling wheel radius when the turning angle of the target wheel is less than or equal to the predetermined angle reference value.

The shoulder portions 29 of the target wheel contact the ground when the turning angle of the target wheel is larger than the specific angle. Therefore, the curved-traveling wheel radius calculated based on the ground speed of the target wheel that corresponds to the turning angle of the target wheel being smaller than the specific angle may not accurately reflect the degree of wear of the shoulder portions 29 of the target wheel.

The wear determination system 100 calculates the curved-traveling wheel radius based on the ground speed that corresponds to the turning angle of the target wheel being larger than the angle reference value. As a result, the wear determination system 100 can more precisely determine wear of the shoulder portions 29 of the target wheel.

(6) The wear determination system 100 does not calculate the curved-traveling wheel radius when the moving speed of the vehicle 10 that corresponds to the vehicle 10 being turning right or left is greater than or equal to the predetermined speed reference value.

When the vehicle 10 turns right or left in a state in which the moving speed of the vehicle is high, the vehicle 10 slips. When the vehicle 10 slips, the wear determination system 100 cannot accurately calculate the ground speed of the wheel. The wear determination system 100 calculates the curved-traveling wheel radius based on the ground speed of the target wheel that corresponds to the vehicle 10 turning right or left and the moving speed of the vehicle 10 is low. As a result, the wear determination system 100 can more precisely determine wear of the shoulder portions 29 of the target wheel.

(7) The wear determination system 100 determines wear of the right shoulder portion 29 of the target wheel using the curved-traveling wheel radius calculated based on the ground speed and the rotation speed that corresponds to the vehicle 10 turning right. The wear determination system 100 determines wear of the left shoulder portion 29 of the target wheel using the curved-traveling wheel radius calculated based on the ground speed and the rotation speed that corresponds to the vehicle 10 turning left.

When the vehicle 10 is turning right, the right shoulder portion 29 of the target wheel contacts the ground. When the vehicle 10 is turning left, the left shoulder portion 29 of the target wheel contacts the ground. The wear determination system 100 changes the shoulder portions 29 that determine wear according to the traveling direction of the vehicle 10. As a result, the wear determination system 100 can more precisely determine wear of the left and right shoulder portions 29 of the target wheel.

(8) The wear determination system 100 includes the wear determination device 25 and the information transmission device 11. The information transmission device 11 calculates the curved-traveling wheel radius based on the ground speed of the target wheel and the rotation speed of the target wheel acquired in the same section where the vehicle 10 is turning right or left. The information transmission device 11 transmits the curved-traveling wheel radius to the wear determination device 25. The wear determination device 25 determines wear of the shoulder portions 29 of the target wheel based on the curved-traveling wheel radius.

In the wear determination system 100, the information transmission device 11 calculates the curved-traveling wheel radius. In the wear determination system 100, the wear determination device 25 observes the curved-traveling wheel radius calculated by the information transmission device 11. As a result, the wear determination system 100 can determine wear of the shoulder portions 29 of the target wheel.

(9) In the wear determination system 100, the wear determination device 25 includes the storage device 27. The wear determination device 25 stores the curved-traveling wheel radius received from the information transmission device 11 in the storage device 27.

As the shoulder portions 29 of the target wheel are worn, the curved-traveling wheel radius gradually decreases. The transition of the curved-traveling wheel radius of the target wheel is useful data for confirming the transition of the progress of wear of the shoulder portions 29 of the target wheel.

In the wear determination system 100, the wear determination device 25 stores the curved-traveling wheel radius calculated for the target wheel. According to the wear determination system 100, it is possible to confirm the transition of the curved-traveling wheel radius for the target wheel.

(10) The wear determination device 25 targets a steered wheel included in the vehicle 10 as the target wheel for determination. The wear determination device 25 determines wear of the shoulder portions 29 of the target wheel based on the curved-traveling wheel radius, which is the dynamic loaded radius of the target wheel that corresponds to the vehicle 10 turning right or left. The curved-traveling wheel radius is calculated based on the ground speed of the target wheel and the rotation speed of the target wheel acquired in the same section where the vehicle 10 is turning right or left.

When the shoulder portions 29 of the target wheel are worn, the dynamic loaded radius of the target wheel that corresponds to the vehicle 10 turning right or left decreases. The wear determination device 25 observes the dynamic loaded radius of the target wheel that corresponds to the vehicle 10 turning right or left. As a result, the wear determination device 25 can determine wear of the shoulder portions 29 of the target wheel.

(11) The information transmission device 11 can communicate with the wear determination device 25. The information transmission device 11 calculates the curved-traveling wheel radius, which is the dynamic loaded radius of the target wheel that corresponds to the vehicle 10 turning right or left, based on the ground speed of the target wheel and the rotation speed of the target wheel acquired in the same section where the vehicle 10 is turning right or left. The information transmission device 11 transmits the curved-traveling wheel radius to the wear determination device 25.

The information transmission device 11 calculates the dynamic loaded radius of the target wheel that corresponds to the vehicle 10 turning right or left. As a result, the information transmission device 11 can cause the wear determination device 25 to determine wear of the shoulder portions 29 of the target wheel.

### Modifications

The present embodiment can be implemented with modifications as described below. The present embodiment and the following modifications can be implemented in combination with each other within a range which is not technically contradictory.

In the above embodiment, the wear determination system 100 targets both the FL wheel 21 and the FR wheel 22, which are the steered wheels of the vehicle 10. The wear determination system 100 may target any one of the steered wheels of the vehicle 10.

In the above embodiment, the vehicle 10 includes the yaw rate sensor 15. The brake ECU 12 acquires a yaw rate that corresponds to the vehicle 10 turning left or right from the yaw rate sensor 15. In the wear determination system 100, the vehicle 10 does not necessarily need to include the yaw rate sensor 15. For example, the brake ECU 12 may acquire the yaw rate by dividing the difference between the ground speed of the RL wheel 23 and the ground speed of the RR wheel 24 that corresponds to the vehicle 10 turning left or right by the length between the RL wheel 23 and the RR wheel 24.

In the above embodiment, the vehicle 10 includes the speed sensor 16. The brake ECU 12 acquires the moving speed of the vehicle 10 from the speed sensor 16. In the wear determination system 100, the vehicle 10 does not necessarily need to include the speed sensor 16. The brake ECU 12 may acquire the ground speed of the wheel of the vehicle 10 as the moving speed of the vehicle 10. The brake ECU 12 may acquire the moving speed of the vehicle 10 from the position information of the vehicle 10.

The brake ECU 12 according to the above embodiment extracts a period in which the turning angle of the target wheel is larger than the angle reference value as a period for calculating the curved-traveling wheel radius in the determination period extraction process of FIG. 8. The brake ECU 12 may extract, as the period for calculating the curved-traveling wheel radius, any period during which it is determined that the vehicle 10 is turning right or left regardless of the magnitude of the turning angle of the target wheel.

The wear determination system 100 according to the above embodiment determines that the vehicle 10 is traveling straight when the steering angle of the steering wheel is greater than or equal to 0 degrees and less than 90 degrees in the steering angle determination process of FIG. 5. The wear determination system 100 determines that the vehicle 10 is turning right or left when the steering angle of the steering wheel is greater than or equal to 90 degrees. The magnitude of the steering angle used as a reference for determination by the wear determination system 100 is not limited to the above embodiment.

As illustrated in FIG. 10, when both the straight-traveling wheel radius and the curved-traveling wheel radius are calculated, the information transmission device 11 according to the above embodiment transmits the information indicating the straight-traveling wheel radius and the curved-traveling wheel radius. When only one of the straight-traveling wheel radius and the curved-traveling wheel radius is calculated, the information transmission device 11 may transmit information indicating the calculated value. A configuration may be adopted wherein the wear determination device 25 determines wear of the shoulder portions 29 when both the straight-traveling wheel radius and the curved-traveling wheel radius are available even if the information indicating the straight-traveling wheel radius and the information indicating the curved-traveling wheel radius are received from the information transmission device 11 at different timings.

The wear determination device 25 according to the above embodiment determines wear of each of the left and right shoulder portions 29 of the target wheel. The wear determination device 25 may determine wear of the shoulder portions 29 of the target wheel without distinguishing between the right side and the left side.

The information transmission device 11 according to the above embodiment transmits, to the wear determination device 25, the information indicating the straight-traveling wheel radius and the curved-traveling wheel radius as the information on the vehicle 10. The information on the vehicle 10 transmitted by the information transmission device 11 is not limited to the above embodiment. For example, the information transmission device 11 may transmit the information indicating the difference between the straight-traveling wheel radius and the curved-traveling wheel radius to the wear determination device 25.

In the above embodiment, the wear determination device 25 determines wear of the shoulder portions 29 after the information transmission device 11 calculates the straight-traveling wheel radius and the curved-traveling wheel radius. In the wear determination system 100, the wear determination device 25 may calculate the straight-traveling wheel radius and the curved-traveling wheel radius.

In this case, the wear determination device 25 acquires values measured by multiple sensors of the vehicle 10 in the calculation period. The wear determination device 25 executes, in place of the brake ECU 12, the processes executed by the brake ECU 12 in FIGS. 5, 7, and 8.

It is also conceivable that when the wear determination device 25 calculates the straight-traveling wheel radius and the curved-traveling wheel radius, the brake ECU 12 executes some of the processes of FIGS. 5, 7, and 8, and the wear determination device 25 executes the remaining processes of FIGS. 5, 7, and 8.

For example, after executing the steering angle determination process of FIG. 5, the brake ECU 12 may transmit information indicating the measurement values of the sensor for each divided period to the wear determination device 25. For example, after executing the steering angle determination process of FIG. 5 and the determination period extraction process of FIG. 8, the brake ECU 12 may transmit information indicating values necessary for calculating the straight-traveling wheel radius and the curved-traveling wheel radius to the wear determination device 25.

In the above wear determination system 100, the wear determination device 25 is a server installed outside the vehicle 10. The wear determination device 25 may be an in-vehicle device. In this case, the information transmission device 11 does not need to include the communication device 13.

In the above embodiment, the wear determination system 100 includes the information transmission device 11 that calculates the straight-traveling wheel radius and the curved-traveling wheel radius, and the wear determination device 25 that determines wear of the shoulder portions 29. In the wear determination system 100, one device including a processing circuitry may execute calculation of the straight-traveling wheel radius and the curved-traveling wheel radius and determination of wear of the shoulder portions 29.

In the above embodiment, the wear determination system 100 determines wear of the shoulder portions 29 by comparing the straight-traveling wheel radius and the curved-traveling wheel radius. The wear determination system 100 does not necessarily need to use the straight-traveling wheel radius to determine wear of the shoulder portions 29. The wear determination system 100 may determine that the shoulder portions 29 are worn when the curved-traveling wheel radius is less than a threshold value. The wear determination system 100 may determine that the shoulder portions 29 are worn when the difference between the curved-traveling wheel radius and a predetermined value is greater than or equal to a threshold value. The wear determination system 100 may store the calculated curved-traveling wheel radius and determine wear of the shoulder portions 29 based on a transition of the curved-traveling wheel radius.

In the above embodiment, the wear determination device 25 determines wear of the shoulder portions 29 based on the difference between the straight-traveling wheel radius and the curved-traveling wheel radius. The wear determination device 25 may determine wear of the shoulder portions 29 based on a ratio of the curved-traveling wheel radius to the straight-traveling wheel radius.

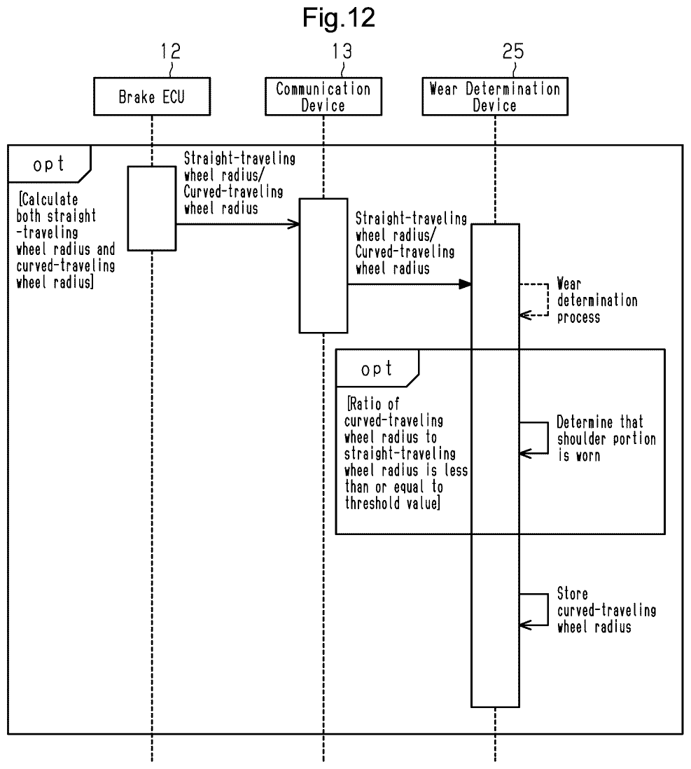

FIG. 12 illustrates a mode of communication executed by the wear determination device 25 to determine wear of the shoulder portions 29 of the target wheel in the wear determination system 100 of the first modification. In the first modification, the mode of communication illustrated in FIG. 12 is executed instead of the mode of communication illustrated in FIG. 10.

In FIG. 12, a mode in which the brake ECU 12 transmits the information indicating the straight-traveling wheel radius and the curved-traveling wheel radius to the communication device 13 and then the communication device 13 transmits the information to the wear determination device 25 is similar to the mode of FIG. 10.

As illustrated in the upper part of FIG. 12, the wear determination device 25 executes the wear determination process in the same manner as in the upper part of FIG. 10.

In the wear determination process, the wear determination device 25 observes the ratio of the curved-traveling wheel radius to the straight-traveling wheel radius. The wear determination device 25 observes a ratio of b2 to b1 when determining wear of the right shoulder portion 29 of the FL wheel 21. The wear determination device 25 observes a ratio of b3 to b1 when determining wear of the left shoulder portion 29 of the FL wheel 21. The wear determination device 25 observes a ratio of c2 to c1 when determining wear of the right shoulder portion 29 of the FR wheel 22. The wear determination device 25 observes a ratio of c3 to c1 when determining wear of the left shoulder portion 29 of the FR wheel 22.

As the shoulder portions 29 are worn, the curved-traveling wheel radius decreases in a manner that the ratio of the curved-traveling wheel radius to the straight-traveling wheel radius decreases. As illustrated in the lower part of FIG. 12, the wear determination device 25 determines that the shoulder portions 29 of the target wheel are worn when the ratio of the curved-traveling wheel radius to the straight-traveling wheel radius is less than or equal to a threshold value.

The wear determination device 25 determines that the right shoulder portion 29 of the FL wheel 21 is worn when the ratio of b2 to b1 is less than or equal to a threshold value. The wear determination system 100 calculates the straight-traveling wheel radius, which is the dynamic loaded radius of the target wheel that corresponds to the vehicle 10 traveling straight. The wear determination system 100 determines that the shoulder portions 29 of the target wheel are worn when the ratio of the curved-traveling wheel radius to the straight-traveling wheel radius is less than or equal to the threshold value.

As illustrated in the lower part of FIG. 12, after determining wear of the shoulder portions 29, the wear determination device 25 stores the curved-traveling wheel radius received from the information transmission device 11 in the storage device 27. This process is similar to the process executed by the wear determination device 25, which is illustrated in the lower part of FIG. 10.

In this case, the wear determination system 100 calculates the straight-traveling wheel radius, which is the dynamic loaded radius of the target wheel that corresponds to the vehicle 10 traveling straight. The wear determination system 100 determines that the shoulder portions 29 of the target wheel are worn when the ratio of the curved-traveling wheel radius to the straight-traveling wheel radius is less than or equal to the threshold value.

As the shoulder portions 29 of the target wheel are worn, the dynamic loaded radius that corresponds to the vehicle 10 turning right or left becomes smaller than the dynamic loaded radius that corresponds to the vehicle 10 traveling straight. The wear determination system 100 observes the ratio of the curved-traveling wheel radius to the straight-traveling wheel radius. As a result, the wear determination system 100 can determine wear of the shoulder portions 29 of the target wheel.

Various changes in form and details may be made to the examples above without departing from the spirit and scope of the claims and their equivalents. The examples are for the sake of description only, and not for purposes of limitation. Descriptions of features in each example are to be considered as being applicable to similar features or aspects in other examples. Suitable results may be achieved if sequences are performed in a different order, and/or if components in a described system, architecture, device, or circuit are combined differently, and/or replaced or supplemented by other components or their equivalents. The scope of the disclosure is not defined by the detailed description, but by the claims and their equivalents. All variations within the scope of the claims and their equivalents are included in the disclosure.

What is claimed is:

1. A wear determination system that determines wear of a target wheel that is a steered wheel included in a vehicle, the wear determination system being configured to
calculate a ground speed of the target wheel and a rotation speed of the target wheel, the ground speed and the rotation speed being acquired in a same section where the vehicle is turning right or left,
calculate a curved-traveling wheel radius, which is a dynamic loaded radius of the target wheel that corresponds to the vehicle turning right or left, based on the ground speed and the rotation speed, and
determine wear of a shoulder portion of the target wheel based on the curved-traveling wheel radius.

2. The wear determination system according to claim 1, wherein the wear determination system is configured to calculate the ground speed of the target wheel that corresponds to the vehicle turning right or left based on a yaw rate of the vehicle and a turning angle of the target wheel acquired in the same section where the vehicle is turning right or left, and a wheelbase length of the vehicle.

3. The wear determination system according to claim 1, wherein the wear determination system is configured to
calculate a straight-traveling wheel radius, which is the dynamic loaded radius of the target wheel that corresponds to the vehicle traveling straight, and
determine the shoulder portion of the target wheel to be worn when a difference between the curved-traveling wheel radius and the straight-traveling wheel radius is greater than or equal to a threshold value.

4. The wear determination system according to claim 1, wherein the wear determination system is configured to
calculate a straight-traveling wheel radius, which is the dynamic loaded radius of the target wheel that corresponds to the vehicle traveling straight, and
determine the shoulder portion of the target wheel to be worn when a ratio of the curved-traveling wheel radius to the straight-traveling wheel radius is less than or equal to a threshold value.

5. The wear determination system according to claim 3, wherein the wear determination system is configured to calculate the straight-traveling wheel radius based on the ground speed of the target wheel and the rotation speed of the target wheel acquired in the same section where the vehicle is traveling straight.

6. The wear determination system according to claim 1, wherein the wear determination system is configured to not calculate the curved-traveling wheel radius when a turning angle of the target wheel is less than or equal to a predetermined angle reference value.

7. The wear determination system according to claim 1, wherein the wear determination system is configured to not calculate the curved-traveling wheel radius when a moving speed of the vehicle that corresponds to the vehicle turning right or left is greater than or equal to a predetermined speed reference value.

8. The wear determination system according to claim 1, wherein the wear determination system is configured to
determine wear of the shoulder portion on a right side in a traveling direction of the target wheel using the curved-traveling wheel radius calculated based on the ground speed and the rotation speed that correspond to the vehicle turning right, and
determine wear of the shoulder portion on a left side in the traveling direction of the target wheel using the curved-traveling wheel radius calculated based on the ground speed and the rotation speed that correspond to the vehicle turning left.

9. The wear determination system according to claim 1, comprising:
a wear determination device; and
an information transmission device, wherein
the information transmission device is configured to
calculate the ground speed of the target wheel and the rotation speed of the target wheel in the same section where the vehicle is turning right or left,
calculate the curved-traveling wheel radius based on the ground speed and the rotation speed, and
transmit the curved-traveling wheel radius to the wear determination device, and
the wear determination device is configured to determine wear of the shoulder portion of the target wheel based on the curved-traveling wheel radius.

10. The wear determination system according to claim 9, wherein the wear determination device includes a storage device and is configured to store, in the storage device, the curved-traveling wheel radius received from the information transmission device.

11. A wear determination device that determines wear of a target wheel that is a steered wheel included in a vehicle, the wear determination device comprising processing circuitry, wherein
the processing circuitry is configured to determine wear of a shoulder portion of the target wheel based on a curved-traveling wheel radius, which is a dynamic loaded radius of the target wheel that corresponds to the vehicle turning right or left, and
the curved-traveling wheel radius is calculated based on a ground speed of the target wheel and a rotation speed of the target wheel that are acquired in a same section where the vehicle is turning right or left.

12. An information transmission device configured to communicate with the wear determination device according to claim 11, the information transmission device comprising:
processing circuitry; and
a communication device, wherein
the processing circuitry of the information transmission device is configured to
calculate the ground speed of the target wheel and the rotation speed of the target wheel in the same section where the vehicle is turning right or left, and
calculate the curved-traveling wheel radius based on the ground speed and the rotation speed, and
the communication device is configured to transmit the curved-traveling wheel radius to the wear determination device.
